(19) United States
(12) Patent Application Publication
(10) Pub. No.: US 2026/0366306 A1
(43) Pub. Date: Nov. 19, 2026

(54) Decorative Panel, Decorative Covering, and Method of Manufacturing Such a Decorative Panel

(71) Applicant: Eddy Alberic Boucké, Turnhout (BE)

(72) Inventor: Eddy Alberic Boucké, Turnhout (BE)

(21) Appl. No.: 19/143,928

(22) PCT Filed: Dec. 28, 2023
(86) PCT No.: PCT/EP2023/087939

§ 371 Date: Jun. 27, 2025

(30) Foreign Application Priority Data
Dec. 28, 2022 (NL) 2033858

(51) Int. Cl. E04F 15/10; E04F 15/02

(52) U.S. Cl. CPC E04F 15/105; E04F 15/02038; E04F 2201/0138; E04F 2201/0153; E04F 2201/023; E04F 2201/042; E04F 2201/043

(57) ABSTRACT

The present invention relates to a decorative panel, such as a floor panel. The panels includes at least one core layer provided with a support side and a decorative side; a decorative top layer, affixed directly or indirectly to the decorative side of the core layer; wherein the core layer comprises coupling parts, integrated with the core layer, to mutually couple panels; and wherein the core layer and/or the decorative top structure comprises glass particles, at least partially integrated in the core layer and/or decorative top layer.

### CROSS-REFERENCE TO RELATED APPLICATIONS

This application is the United States national phase of International Patent Application No. PCT/EP2023/087939 filed Dec. 28, 2023, and claims priority to The Netherlands Patent Application No. 2033858 filed Dec. 28, 2022, the disclosures of which are hereby incorporated by reference in their entireties.

### BACKGROUND OF THE INVENTION

### Field of the Invention

The present invention relates to a decorative panel, such as a floor panel, comprising at least one core layer provided with a support side and a decorative side and a decorative top layer, affixed directly or indirectly to the decorative side of the core layer. The invention further relates to decorative covering composed of a plurality of, preferably mutually coupled, decorative panels according to the invention. The invention further relates to a method of manufacturing a decorative panel according to the invention.

### Description of Related Art

In the field of decorative floor coverings, decorative panels are known having a MDF (Medium Density Board) or HDF (High Density Board) based core layer on top of which a decorative substrate is attached to provide the panels a desired appearance. A major disadvantage of these known panels is the hygroscopic nature of the core layer, which affects the lifetime and durability of such panels. For this reason, the traditional MDF/HDF based panels are more and more replaced by thermoplastic based or polyvinyl chloride (PVC) based panels, also provided with a decorative substrate on top. These PVC based panels have the advantage over of being relatively waterproof compared to MDF/HDF based panels. The drawback, however, of these PVC based panels is that the temperature resistance is very poor, as a result of which these panels will typically easily deform (curve) in case these panels are exposed to a heating source, like a heating radiator or even a lamp. Moreover, a common additional important drawback of both the MDF/HDF based panels and the PVC based panels is the flammability of these panels. Flammability of furniture is of concern as, for example, cigarettes and candle accidents can easily trigger domestic fires. Hence, there is a general need in the field of decorative flooring to further develop decorative panels to counteract at least one of the above drawbacks, and in particular to develop a decorative panel which is relatively fireproof. There is an additional need to develop a decorative panel having an improved dimensional stability when subjected to temperature fluctuations during regular use.

### SUMMARY OF THE INVENTION

To that end the present invention proposes a decorative panel, such as a floor panel, comprising at least one core layer provided with a support side and a decorative side; a decorative top layer, decorative layer or decorative top structure, affixed directly or indirectly to the decorative side of the core layer; wherein the core layer optionally comprises coupling parts, integrated with the core layer, to mutually couple panels; and wherein the core layer and/or the decorative top structure may comprise glass particles, preferably at least partially integrated in the core layer and/or decorative top layer. The panel may further comprise a backing layer affixed directly or indirectly to the support side of the core layer.

The invention among other aspects proposes to use glass particles as fillers or filling material and/or as strengthening or reinforcing material in at least one of the layers of the panel. Although the use of fillers and filling material in panels to reduce cost is well known in the art, these fillers typically have an adverse effect in the fire resistant of flame retardant properties of the panels and are not waterproof. Similar observations can be made for reinforcing materials (such as glass fibres) which are used to strengthen panels, in particular plastic panels, which additionally can be sharp and unsafe glass fibres. Glass particles on the other hand do not have such adverse effect on the fire resistant of flame retardant properties of the panels and have been found to strengthen or stabilize panels when incorporated in the panel material(s). Moreover they are widely available and relatively cheap, making them a good candidate as filling material. The glass particles can be used to strengthen and fill the at least one core layer for instance, but may also be used to strengthen the decorative layer on top.

Particles in this regard may be considered as non-fibrous, they are relatively small objects, which may vary in size but are not long strands or fibres. The particles may for instance substantially be polyhedron shaped. For example they may have a rhombic triacontahedron or icosidodecahedron shape. In general a polyhedron may be defined as a three-dimensional shape with flat polygonal faces, straight edges and sharp corners or vertices. The glass particles may for instance also be glass spheres, preferably solid spheres, which can be distributed very evenly and have no sharp edges.

In a preferred embodiment the glass particles are substantially spherical, or spherical, in shape and/or form glass beads. Another side effect of the spherical nature of the particles is that the effect on the viscosity of the resin is minimised. A better flowing resin not only allows parts to be produced more quickly, but it also results in a more isotropic filling of the mould. This in turn leads to composite parts in which stresses are more uniformly distributed. In contrast, angular fillers such as talc or glass fibres tend to interlock at higher loadings resulting in stress concentrations and fracture points in the cured part. Spherical glass particles may also be used to avoid clumping or grouping of filler materials, like the angular filler materials, which prevents the formation of filler agglomerates and thus improves even distribution of material throughout the panel.

The glass particles may be provided in the core layer, preferably evenly or uniformly distributed through the core layer. The core layer in decorative panels typically is the thickest layer and provides the bulk material to the panels. In order to provide the most stability and strength to the panel, including the glass particles in the core provides the biggest benefits. In an embodiment of the invention the glass particles are provided in the core layer or core layers, but are absent in the decorative layer and/or the backing layer of the panels.

The glass particles may also be provided in the decorative layer, preferably evenly or uniformly distributed through the decorative layer, wherein preferably the at least some of the glass particles extend outward of the decorative top layer to provide a textured top surface. This may be instead of or additional to the inclusion of the particles in the at least one core layer. Although the benefits are similar in that the decorative top layer may be strengthened this way, using the particles in the decorative layer may result in at least a portion of at least some of the glass particles to extent from the decorative layer, sticking out of the panel. This way the particles may provide a texture to the decorative layer, which would increase friction of the decorative side of the panel and prevents slipping on the panel.

Preferably, the decorative panel according to the invention comprises a first panel edge comprising a first coupling profile, and a second panel edge, opposing said first panel edge, comprising a second coupling profile being designed to engage interlockingly with said first coupling profile of an adjacent panel, preferably both in horizontal direction and in vertical direction, wherein the core layer is an extruded core layer and comprises at least one thermoplastic matrix material and glass particles dispersed within said thermoplastic matrix material, wherein cavities are enclosed by at least a fraction of said glass particles and said thermoplastic material. The cavities are normally formed because of the weak interfacial adhesion caused by lack of matrix polarity, and in particular the difference in polarity between the (non-polar) thermoplastic matrix material and the glass particles. During extrusion at elevated temperatures (dependent on the thermoplastic used, but typically situated between 180 and 280 degrees Celsius), at least a fraction of the glass particles normally becomes poled. The glass particles typically comprise silicon dioxide (SiO₂; silica). SiO₂ has polar Si—O bonds; however, due to the symmetry of these bonds, the dipole moments cancel out in normal state. During thermal poling of the glass, this charge symmetry is disturbed, resulting in permanent dipoles formation, which is also referred to as poled glass. Hence, the composite core layer material will therefore have a heterogeneous structure in which the glass particles and cavities, typically microvoids, are dispersed in the thermoplastic matrix. The cavities are thus created due to a lack of compatibility between the thermoplastic matrix material and the glass particles, in particular the poled glass particles. The presence of these cavities increases the elasticity of the core layer, as a result of which the presence of glass particles and the resulting cavities in the matrix material in fact plasticizes the matrix material in an efficient and environmental friendly manner. The degree of plasticization (flexibilization) of the core layer often depends on the number (and size) of the cavities, which as such depends on the number and shape of the glass particles. Preferably, the glass particles are uncoated glass particles, in particular uncoated glass beads (glass microspheres). Contrary to traditional glass fiber fillers used in floor panels (which are all coated to realize a solid and entire connection between the glass fibers and a surrounding thermoplastic material), the lack of using any coating hinders the interfacial adhesion between the glass particles and the thermoplastic matrix material, which results into a reduced contact surface between the glass and the thermoplastic matrix material as well as into the formation of one or more cavities around each glass particle of at least a fraction of the glass particles applied in the core layer (and/or decorative surface layer). Hence, contrary to traditional solution, in this case a poor adhesion of the glass particles to the thermoplastic material is desired to stimulate cavity formation in order to increase the elasticity of the core layer. The weak interfacial adhesion of the glass particles to the thermoplastic matrix also facilitates post-consumer separation of the glass particles and the thermoplastic matrix for recycling purposes. Preferably, less than 50% of the outer surface of the glass particles is adhered to the thermoplastic matrix material, and wherein, in average, more than 50% of the outer surface of the glass particles is positioned at a distance from the thermoplastic matrix material. This normally secures sufficient flexibility of the core layer. Preferably, at least a fraction, preferably the majority, of the cavities has an elongated shape. The shape of the cavities normally changes during extrusion, wherein the cavities will be stretched and will obtain a sort of ellipsoidal shape, typically with a longitudinal axis which runs substantially parallel to the extrusion direction and which normally runs substantially parallel to at least one pair of opposite core layer edges. This deformation in longitudinal direction further contributes to improve the flexibility of the core layer, and hence of the panel as such. A higher elasticity of the core layer facilitates installation of the coupling profiles. Since the one or more coupling profiles (of adjacent panels) either (i) are configured to engage interlockingly with said first coupling profile of an adjacent panel, both in horizontal direction and in vertical direction, (ii) and/or are adapted to deform during coupling process of adjacent decorative panels, (iii) and/or configured to remain deformed state, in coupled condition of adjacent decorative panels, some flexibility of the coupling profiles is desired (and needed) to realize these technical effects, which flexibility can be obtained by the use of glass particles and neighbouring cavities dispersed in the thermoplastic material of the core layer. In this case, it is preferred that the coupling profiles make integral part of the core layer and can e.g. be formed by profiling, e.g. by means of milling, two or more core layer edges. Typically, at least one pair of opposing panel edges, in particular core layer edges, is provided with first and second coupling profiles. Optionally, at least one other pair of opposing panel edges, in particular core layer edges, may be provided with further coupling profiles, which may also be first and second coupling profiles, or which may comprise at least one alternatively shaped coupling profile.

Optionally, the core layer and/or the decorative surface layer comprises conductive particles, such as carbon particles, dispersed in the thermoplastic matrix material. These particles may be used to dissipate electrical energy in order to reduce or eliminate build-up of static electricity in the core layer and/or the decorative surface layer and/or at a top surface of the panel.

The glass particles are preferably uncoated, unlike typical glass fibres used commonly in flooring products. The glass particles, although embedded at least partially in the layer(s) of the panels according to the present invention, are preferably not bonded to the matrix or material of the layer(s). This allows separation of the glass particles from the rest of the panel, in particular during recycling of the panels after use.

In a preferred embodiment the glass particles are comprised in the layer(s) of the panel in such a way that the particles are surrounded by an air cavity at least partially, such that air is present between the glass particle and the material of the layer(s) at least somewhere along the circumference of at least one glass particle. The glass particles according to the invention are thus preferably used predominantly as a filler material and less as load bearing component. By providing the glass particles in an air cavity, which may be the result of not coating the particles such that no bonding with the matrix or material of the panel occurs, the material of the layer(s) is interrupted. This interruption of the layer(s) improves sound dampening, due to a local material transition, but it also hinders or stops crack propagation in the panel. When a crack forms somewhere in the panel and encounters the cavity, stresses are relieved and propagation of the crack is stopped at the cavity.

The core layer and/or the decorative layer and/or the backing layer may comprise up to 50% by weight of melamine cyanurate, preferably between 5 and 40%. This compound, also known as melamine-cyanuric acid adduct or melamine-cyanuric acid complex, may for example be a crystalline complex formed from a 1:1 mixture of melamine and cyanuric acid. The melamine cyanurate to be used according to the invention is preferably composed of particles with average particle diameters from up to 120 μm, particularly preferably from 1 μm to 25 μm, very particularly preferably from 1 μm to 10 μm,. In this application um and micron are interchangeable terms. The melamine particles may wherein have a d90 below 120 120 μm, preferably below 25 μm. These melamine particles may have been surface-treated or coated or sized with known compositions or materials. Among these materials are organic compounds which can have been applied in monomeric, oligomeric and/or polymeric form to the melamine cyanurate. Coating systems that can be used with particular preference are those based on silicon-containing compounds. in particular on organofunctional silanes or on organosiloxanes. It is equally possible to use coatings with inorganic components. Melamine cyanurate has been found to improve the flame retardant properties of the panels according to the invention. The invention may thus provide a decorative panel, such as a floor panel, comprising at least one core layer provided with a support side and a decorative side; a decorative top layer, affixed directly or indirectly to the decorative side of the core layer; wherein the core layer optionally comprises coupling parts, integrated with the core layer, to mutually couple panels; and wherein the core layer and/or the decorative top structure may (each individually for instance) comprise up to 50% by weight of melamine cyanurate, preferably between 5 and 40%. The panel may further comprise a backing layer affixed directly or indirectly to the support side of the core layer.

An additional benefit of using melamine cyanurate as flame retardant material in (at least one of the) layers of the panel is that upon recycling, the material of the layers may keep its flame retardant properties.

In a preferred embodiment the melamine cyanurate is predominantly, or solely, present in the top layer. In particular in flooring panels, fires and fire hazards typically occur at the decorative (or top) side of the panels, such that flame retardant properties are most important at that decorative side. Using the compound selectively allows to reduce costs while still maintaining the desired properties of the panels. The decorative top layer may comprise multiple layers, for example comprising an optional base layer, a printed décor and a protective wear layer, wherein the compound may be present in at least one of these layers.

Fire or flame retardants (both terms are used interchangeably) function by interference with one of the three components that initiate and/or support combustion: heat, fuel and oxygen. Melamine shows excellent flame retardant properties because of its ability to interfere with the combustion process in all stages and in many different ways.

In the initial stage melamine can retard ignition by causing a heat sink through endothermic dissociation in case of a melamine salt followed by endothermic sublimation of the melamine itself at roughly 350 °C. Another, even larger, heat sink effect is generated by the subsequent decomposition of the melamine vapours.

Melamine can be regarded as a “poor fuel” having a heat of combustion of only 40% of that of hydrocarbons. Furthermore, the nitrogen produced by combustion will act as inert diluent. Another source of inert diluent is the ammonia which is released during breakdown of the melamine or self-condensation of the melamine fraction which does not sublimate. Melamine can also show considerable contribution to the formation of a char layer in the intumescent process. The char layer acts as a barrier between oxygen and polymeric decomposition gases. Char stability is enhanced by multi-ring structures like melem and melon, formed during self-condensation of melamine. In combination with phosphorous synergists melamine can further increase char stability through formation nitrogen-phosphorous substances. Finally melamine can act as blowing agent for the char, enhancing the heat barrier functionality of the char layer.

The core layer and/or the decorative layer and/or the backing layer may comprise further flame retardant materials, such as nitrogen-containing components like melamine polyphosphate, to further improve flame retardant properties of the panels of the invention.

The material of the core layer and/or decorative layer and/or backing layer may comprise a thermoplastic material like polyvinylchloride (PVC) or polyurethane (PU). When glass particles are used in combination with these materials there are added to the thermoplastic matrix, which improves the properties of the layers in terms of flexural modulus, stiffness, tensile strength, chemical resistance, fire resistance and coefficient of friction. In chloride group containing materials, the glass particles may act similar to ball bearings, where they nestle between the chloride groups of adjacent material layers, for example reducing attraction between these material layers.

The decorative layer may further comprise an anti-slip substance chosen from the group consisting of: carborundum, corundum, quartz, silica, feldspar, clay, ceramic, carbon, textile, or fused aluminium oxide. In general, larger particle sizes typically increases the wear resistance. The anti-slip substance may lead to a textured upper surface of the decorative layer. The anti-slip substance may improve the look and feel of the panel, and moreover provides the panel with anti-slip properties. This latter will lead to more safe coverings composed of a plurality of panels according to the invention, in particular in humid environments, such as bathrooms, swimming pools, or outdoor, with a reduced risk of injuries and accidents.

Preferably, at least one intermediate layer is situated in between at least one core layer and the decorative layer. Preferably, at least one core layer, preferably each core layer, said intermediate layer, and said decorative layer are co-extruded layers. The intermediate layer may for instance be a reinforcement layer, sealing layer, primer layer, adhesive layer, and/or alternative functional layer. Preferably, the intermediate layer is thinner than the decorative layer. Preferably, the intermediate layer is thinner than at least one adjacent core layer.

The decorative layer may form part of a decorative top structure. This top structure may comprise a protective or wear layer situated above the decorative layer, to protect the decorative layer and possibly the core layers. The decorative layer may solely be formed by an ink layer representing a decor. The decorative layer may also comprises an ink carrying layer, such as a paper or polymeric film, carrying an ink layer representing the décor. Alternatively, it is imaginable that the decorative layer is a coloured layer, such as a polymer layer enriched with one or more colorants. The colour of the decorative layer may be a solid colour or may be composed of a plurality of colours. Typically, the decor defines a motif, an image, and/or a pattern, preferably composed of various colours. The decor is preferably printed, more preferably digitally printed, with (coloured) ink onto another panel layer, such as an ink carrying layer, in particular a film, typically composed of paper and/or thermoplastic material. The decor contributes to the visual appearance (the “looks”) of the decorative panel. One or more protective layers applied on top of the decor layer in order to protect the decor layer may have a textured upper surface or relief structure. Said textured upper surface or relief structure, also referred to as embossing structure, preferably matches the visuals of the decor at least partially, preferably entirely. This alignment is also referred as an alignment in register. This is for example attractive for imitated wood pattern, wherein the relief structure may comprise a plurality of impressions or cavities and/or grooves created by printing the relief structure, which are in register with the wood nerves and wood pores of the printed wood pattern. The location and depth of the impressions, cavities, and/or grooves, being a function of the wood nerves and wood pores of the printed pattern. The relief structure gives an improved and more realistic look-and-feel effect to the eventual decorative panels.

At least one protective layer may be a cured layer, such as an UV cured lacquer layer, which is preferably situated as uppermost layer. At least one other protective layer, preferably located underneath said cured layer (if applied) is configured to act as wear layer, and may be enriched with wear-resistant particles, such as aluminium oxide.

The decorative top structure preferably comprises at least one primer layer, at least one a décor layer on top of said primer layer, and at least one protective layer are applied on top of said decor layer. Preferably, said primer layer has white or whitish colour which will be in favour of the colour appearance (colour authenticity) of the printed decor applied, preferably directly, on top of said primer layer. The primer layer may for example comprise melamine cyanurate.

The decorative layer may have a thickness which is preferably situated between 0.03 and 0.2 mm. The decorative top structure preferably has a thickness between 0.2 and 1.2 mm, more preferably between 0.3 and 0.8 mm. The backing layer may be a polymer, in particular thermoplastic, based layer and/or a cork layer. Preferably, said backing layer, at least one core layer, preferably each core layer, and said decorative layer are co-extruded layers. The thickness of the back layer is preferably between 1 and 2.5 mm, more preferably between 1.5 and 2.0 mm. The panel thickness may vary but is preferably situated in between 3.5 and 15 mm.

The decorative panel may further comprise a back layer affixed directly or indirectly to the support side of the core layer, wherein the glass particles are provided in the back layer, preferably evenly or uniformly distributed through the back layer, wherein preferably the at least some of the glass particles extend outward of the back layer to provide a textured bottom surface. The glass particles may be provided in the back layer only or be provided in one or more of the layers of the panel or alternatively in all of the layers of the panel.

Although the benefits are similar in that the back layer may be strengthened this way, using the particles in the back may result in at least a portion of at least some of the glass particles to extent from the back layer, sticking out of the panel. This way the particles may provide a texture to the back layer, which would increase friction of the support side of the panel and prevents movement of the panel on a supporting structure or subfloor.

The at least one core layer and/or the decorative layer and/or the back layer may comprise glass particles in an amount of at least 5%, or at least 10%, or at least 15%, preferably at least 40%, more preferably at least 60%, by weight or volume of the respective layer (wherein the glass particles are dispersed). These amounts have been found to provide the optimum in terms of stability of the panels.

The glass particles used in the layers may be solid, meaning that they do not include air pockets and are non-foamed, which provides the most support to the panel. Alternatively the glass particles may be hollow, meaning they do include air pockets or empty spaces, or the particles may be foamed. The inclusion of air in the particles, or in the layer where the particles are included, reduces the density of the panel which would allow to create a lighter of lightweight panel. Additionally the inclusion of such air or air pockets improves sound absorbing or dampening qualities of the panel, as sound is naturally dampened when it encounters a change in material.

The hollow glass particles may be considers as glass bubbles. These bubbles may for example be made from a water-resistant and chemically stabile soda-lime-borosilicate glass. Glass bubbles have an exceptional ability to reduce the weight of composite parts. Compared to conventional fillers such as talc or calcium carbonate, the density of glass bubbles can be 20 times lower (depending on the grade).

Preferably, at least 90% of the glass particles has a diameter which is smaller than 30 μm (d90<30 μm). The average diameter of the glass particles may be less than 300 μm, preferably less than 200 μm, more preferably less than 150 μm, even more preferably less than 100 μm, wherein the glass particles in particular have a d90 less than 300 μm, preferably less than 200 μm, more preferably less than 150 μm, even more preferably less than 100 μm. The average diameter of the glass particles may for instance be between 10 and 300 μm, preferably between 25 and 100 μm, wherein the glass particles in particular have a d90 between 10 and 300 μm, preferably between 25 and 100 μm. When mentioned in here, when such sizes are discussed, d10 is the particle size which is greater than that of 10% of the particles, d50 is the particle size which is greater than that of 50% of the particles (median) and d90 is the particle size which is greater than that of 90% of the particles.

The at least one core layer, and preferably the decorative layer and/or the back layer, comprises a thermoplastic material, like PVC or polyamide like Nylon, wherein the glass particles are at least partially incorporated or embedded in the thermoplastic material. The thermoplastic material allows the particles to be spread homogeneously throughout the material and is a material already being used widely in the art.

The decorative layer, the at least one core layer and/or the back layer may comprise an extruded panel layer. Preferably, at least one, more preferably each panel layer, and preferably at least one, more preferably each extruded panel layer, comprises at least one thermoplastic material, such as polypropylene (PP), polyurethane (PU), thermoplastic polyurethane (TPU), polystyrene (PS), polyethylene (PE), polyethylene terephthalate (PET), and/or polyvinyl chloride (PVC). Preferably, at least one core layer and/or at least one decorative layer comprises at least one thermoplastic material is chosen from the group consisting of: polypropylene (PP), thermoplastic polyurethane (TPU), polystyrene (PS), polyethylene (PE), polyethylene terephthalate (PET), polyethylene terephthalate glycol (PETG), polyvinyl chloride (PVC), and a furan resin. At least one thermoplastic based layer, such as a core layer, may either be solid or foamed. Although the decorative layer may also be foamed, this layer is in most embodiment a solid (unfoamed) layer, and more in particular a solid film. The polymer used in a panel layer, preferably an extruded panel layer, is preferably at least partially composed of a polymer formed by a mixture of virgin polymer material, recycled polymer material, or a combination of virgin and recycled polymer material. Preferably, at least one the polymer used in a panel layer, preferably an extruded panel layer, is preferably enriched with at least one additive, preferably at least one additive chosen from the group consisting of: talc, chalk, wood, calcium carbonate, titanium dioxide, calcined clay, porcelain, glass particles, glass fibres, carbon particles, silicon particular, a(nother) mineral filler, rice, textile fibers, such as cotton fibers, and another natural filler.

Preferably, said furan resin optionally used in at least one core layer and/or at least one decorative top layer is at least one furan resin selected from the group consisting of: poly(ethylene 2,5-furandicarboxylate) (PEF), poly(propylene 2,5-furandicarboxylate) (PPF), poly(butylene 2,5-furandicarboxylate) (PBF), poly(1,4-cyclohexanedimethylene 2,5-furandicarboxylate) (PCHDMF), poly trimethylene furan dicarboxylate) (PTF), poly (neopentyl 2,5-furandicarboxylate) (PNF) and mixtures thereof. The furan resin optionally used in the panel according to the invention may be a homopolymer or a copolymer, such as random or block copolymers. An example of such a furan (based) copolymer is poly(ethylene 2,5-thiophenedicarboxylate-co-2,5-furandicarboxylate) (PEThF).

Co-extrusion preferably utilizes two or more extruders to melt and deliver a steady volumetric throughput of different viscous plastics to a single extrusion head (die) which will extrude the materials in layers, in particular sheets. The layer thicknesses may be controlled by the relative speeds and sizes of the individual extruders delivering the materials. By using co-extrusion, a laminate of the core layer(s) and the coloured layer, and optional one or more further (thermoplastic based) panel layers, can be manufactured in a relatively fast and cost-efficient manner. This co-extrusion process can be a continuous process. It is hence no longer needed to separately apply a strip of a grout imitating coating after manufacturing (and cooling down) of the panel core. Preferably, the decorative layer covers the entire upper surface of the (upper) core layer. The panel core can be composed of a single extruded layer, but may also be composed of a plurality of extruded core layers and/or of a plurality of core layers wherein at least one core layer is (co-)extruded and wherein other core layer is not (co-)extruded. The different core layers may have an identical composition, but may also have mutually different compositions. The plurality of core layers and the decorative layer may be (co-)extruded simultaneously.

Preferably, following the co-extrusion process, the extruded layers, which are still in softened state, are mutually adhered, preferably means of pressing, in particular hot pressing and/or calendaring by using at least one calender. A calender comprises a series of (hard) pressure rolls used to finish or smooth the extruded panels layer as well as to mutually compress and hence adhere the extruded layers. Calendaring is normally performed when the extruded layers are still and/or brought in softened state. One or more calender rolls of the calender may be heated or cooled, respectively. During the pressing process, in particular the calendaring process, one or more further panel layers may be embedded in the laminate of layers, such as one or more reinforcement layers and/or at least a part of the decorative top structure. One or more reinforcement layers may e.g. be embedded in between two core layers (if a plurality of core layers would be applied), and/or in between the coloured coating and the core. Examples of reinforcement layers are glass-fibre layers and/or textile layers, such as cotton layers. One or more adhered panel layers may be fused together without using a separate adhesive. To this end, it is preferred that the fused panel layer comprise the same or substantially the same thermoplastic polymer(s) to facilitate the fusion process. Alternative or additionally, one or more adhered panel layers may be glued together by using a separate adhesive (glue). As indicated above, it is imaginable that at least one core layer of a plurality of applied core layers of the panel according to the invention is not co-extruded together with other extruded panel layer, and may even not be extruded at all. This increases the freedom of design of the panel.

To further improve the flame-retardant properties of the panel, the core layer may comprises between 0.5-30% by weight of a flame retardant. Alternatively or additionally the flame retardant may be provided in the decorative layer and/or the back layer of the panel.

The coupling parts of the decorative panel, at the decorative side of the core, may comprise a recessed portion in the form of a bevel or grout, wherein a decorative side of the recessed portion may comprise the glass particles, wherein preferably at least a portion of the glass particles extend from the recessed portion to form a structured or textured bevel or grout. By including a recessed portion on top of the coupling parts, a grout or bevel as used in more traditional wooden flooring or tiles is reproduced. In particular with grouts, these spaces between tiles are typically filled in afterwards with a cement-like mixture which has a certain structure. When the glass particles are provided in this portion of the panel and at least a portion of the glass particles extend from the recessed portion, a structure may be provided which mimics the cement-like mixture in terms of texture.

The panels are typically arranged horizontally, wherein the plane of the panel is arranged horizontally. The direction from support side to decorative side of the core is perpendicular to this plane and defines a vertical direction. Preferably, the panel comprises a first panel edge comprising a first coupling profile, and a second panel edge, preferably opposing said first panel edge, comprising a second coupling profile being designed to engage interlockingly with said first coupling profile of an adjacent panel, preferably both in horizontal direction and in vertical direction. Preferably, this locking is such that a relatively tight seam is created in between the panels. This tight seam preferably prevents or impedes penetration of water in between said interconnected panels. This prevents or impedes that the core layer(s) and/or a subfloor (underlying the panel) is/are wettened and possibly affected upon moistening.

Preferably, the first coupling profile and the second coupling profile are configured such that two of such panels can be coupled to each other by means of a turning movement and/or by means of a vertical movement.

It is often preferred that the panel comprises at least one third coupling profile and at least one fourth coupling profile located respectively at a third panel edge and a fourth panel edge. Preferably, the third coupling profile and the fourth coupling profile are configured such that two of such panels can be coupled to each other by means of a turning movement.

In a preferred embodiment, the first coupling profile and/or the third coupling profile comprises: an upward tongue, at least one upward flank lying at a distance from the upward tongue, an upward groove formed in between the upward tongue and the upward flank wherein the upward groove is adapted to receive at least a part of a downward tongue of a second coupling profile of an adjacent panel, and at least one first locking element, preferably provided at a distant side of the upward tongue facing away from the upward flank, and wherein the second coupling profile and/or the fourth coupling profile comprises: a first downward tongue, at least one first downward flank lying at a distance from the downward tongue, a first downward groove formed in between the downward tongue and the downward flank, wherein the downward groove is adapted to receive at least a part of an upward tongue of a first coupling profile of an adjacent panel, and at least one second locking element adapted for co-action with a first locking element of an adjacent panel, said second locking element preferably being provided at the downward flank.

Preferably, the first locking element comprises a bulge and/or a recess, and wherein the second locking element comprises a bulge and/or a recess. The bulge is commonly adapted to be at least partially received in the recess of an adjacent coupled panel for the purpose of realizing a locked coupling, preferably a vertically locked coupling. It is also conceivable that the first locking element and the second locking are not formed by a bulge-recess combination, but by another combination of co-acting profiled surfaces and/or high-friction contact surfaces.

In the abovementioned embodiment, it is imaginable that the first coupling profile (and/or third coupling profile) and the second coupling profile (and/or fourth coupling profile) are configured such that in coupled condition a pretension is existing, which forces coupled panels at the respective edges towards each other, wherein this preferably is performed by applying overlapping contours of the first coupling profile (and/or third coupling profile) and the second coupling profile (and/or fourth coupling profile), in particular overlapping contours of downward tongue and the upward groove and/or overlapping contours of the upward tongue and the downward groove, and wherein the first coupling profile (and/or third coupling profile) and the second coupling profile (and/or fourth coupling profile) are configured such that the two of such panels can be coupled to each other by means of a fold-down movement and/or a vertical movement, such that, in coupled condition, wherein, in coupled condition, at least a part of the downward tongue of the second coupling profile (and/or fourth coupling profile) is inserted in the upward groove of the first coupling profile (and/or third coupling profile), such that the downward tongue is clamped by the first coupling profile (and/or third coupling profile) and/or the upward tongue is clamped by the second coupling profile (and/or fourth coupling profile).

It is imaginable that the first coupling profile is configured to co-act with the second coupling profile as well as with the fourth coupling profile, and that the third coupling profile is also configured to co-act with the second coupling profile as well as with the fourth coupling profile. It is imaginable that the first coupling profile and the fourth coupling profile are identical.

In an embodiment of the panel according to the invention, the first coupling profile and/or the third coupling profile comprises: a sideward tongue extending in a direction substantially parallel to the upper side of the core, at least one second downward flank lying at a distance from the sideward tongue, and a second downward groove formed between the sideward tongue and the second downward flank, and wherein the second coupling profile and/or the fourth coupling profile comprises: a third groove configured for accommodating at least a part of the sideward tongue of the third coupling profile of an adjacent panel, said third groove being defined by an upper lip and a lower lip, wherein said lower lip is provided with an upward locking element, wherein the third coupling profile and the fourth coupling profile are configured such that two of such panels can be coupled to each other by means of a turning movement, wherein, in coupled condition: at least a part of the sideward tongue of a first panel is inserted into the third groove of an adjacent, second panel, and wherein at least a part of the upward locking element of said second panel is inserted into the second downward groove of said first panel.

It is conceivable that each first coupling profile and each third coupling profile is compatible —hence may co-act and interlock-with each second coupling profile and each fourth coupling profile. This may also apply in case interlocking coupling profiles do not have a completely complementary shape.

In a preferred embodiment, at least a coupling profile, and preferably all coupling profiles, is/are at least partially formed by the core.

The panel according to the invention is typically rectangular and may be square or oblong. Alternative shapes, like a triangular shape, a pentagonal shape, a hexagonal shape, or a parallelogrammatic shape, may also be applied as shape for the panel according to the invention.

The invention also relates to a decorative covering composed of a plurality of, preferably interconnected, decorative panels according to the invention.

The invention further relates to a method for producing a decorative panel according to the invention, comprising the steps of:
a) mixing a core layer material and/or a decorative layer material with glass particles;
b) (co)extruding at least one core layer and (preparing) at least a part of at least one decorative layer,
c) mutually adhering said core layer and said decorative layer, preferably by means of hot pressing and/or calendaring,
d) affixing, either directly or indirectly, at least a part of a decorative top structure to an upper side of the decorative layer,
e) optionally, affixing, either directly or indirectly, a backing layer to a lower side of the coextruded layer, and
f) optionally, affixing, either directly or indirectly, a transparent layer on an upper side of the exposed portion of the decorative layer, and
g) optionally, profiling at least one pair of panel edges to form first and second coupling profiles.

Preferably, the at least a part of the decorative top structure is manufactured by means of extrusion and is preferably co-extruded during step a) and adhered to the decorative layer during step b). In an optional step f), coupling profiles may be applied, for example by milling, at at least one pair of opposing edges of the panel. Optionally, in step g) the (base) panel manufactured during steps a)-c) and optionally steps d) and/or e), is cut into smaller panels. Step g), if applied, is preferably performed prior to step f).

Further embodiments of the invention are described in the non-limitative set of clauses presented below.

### Clauses

1. Decorative panel, such as a floor panel, comprising:
   a) at least one, preferably extruded, core layer provided with a support side and a decorative side;
   b) a decorative top layer, affixed directly or indirectly to the decorative side of the core layer;
   c) wherein the core layer optionally comprises coupling parts, integrated with the core layer, to mutually couple panels; and/or wherein a first panel edge comprising a first coupling profile, and a second panel edge, opposing said first panel edge, comprising a second coupling profile being designed to engage interlockingly with said first coupling profile of an adjacent panel, preferably both in horizontal direction and in vertical direction;
   d) wherein the core layer and/or the decorative top layer comprise glass particles, at least partially integrated in the core layer and/or decorative top layer, wherein, preferably, the core layer and/or decorative top layer comprises at least one thermoplastic matrix material wherein said glass particles are dispersed within said thermoplastic matrix material, wherein preferably cavities (voids) are enclosed by at least a fraction of said glass particles and said thermoplastic material.
2. Decorative panel according to clause 1, wherein the glass particles are provided in the core layer, preferably evenly or uniformly distributed through the core layer, wherein preferably the glass particles are at least partially embedded or surrounded by core layer material and/or wherein the glass particles are surrounded by an air cavity in the core layer.
3. Decorative panel according to clause 1 or 2, wherein the glass particles are provided in the decorative top layer, preferably evenly or uniformly distributed through the decorative top layer, wherein preferably at least some of the glass particles extend outward of the decorative top layer to provide a textured top surface.
4. Decorative panel according to any of the preceding clauses, comprising a back layer affixed directly or indirectly to the support side of the core layer, wherein the glass particles are provided in the back layer, preferably evenly or uniformly distributed through the back layer, wherein preferably at least some of the glass particles extend outward of the back layer to provide a textured bottom surface
5. Decorative panel according to any of the preceding clauses, wherein the core layer and/or the decorative top layer and/or the back layer comprise at least 15%, by weight or volume, glass particles, preferably at least 40%, more preferably at least 60%.
6. Decorative panel according to any of the preceding clauses, wherein the glass particles are glass spheres, preferably solid spheres, or wherein the glass particles are polyhedron shaped.
7. Decorative panel according to any of the preceding clauses, wherein the average diameter of the glass particles is less than 300 μm, preferably less than 150 μm, wherein the glass particles in particular have a d90 less than 300 μm, preferably less than 150 μm.
8. Decorative panel according to any of the preceding clauses, wherein the average diameter of the glass particles is between 10 and 300 μm, preferably between 25 and 100 μm, wherein the glass particles in particular have a d90 between 10 and 300 μm, preferably between 25 and 100 μm.
9. Decorative panel according to any of the preceding clauses, wherein the core layer comprises a thermoplastic material, like PVC or polyamide like Nylon, wherein the glass particles are at least partially incorporated or embedded in the thermoplastic material.
10. Decorative panel according to any of the preceding clauses, wherein the core layer, and preferably also the decorative layer and/or the backing layer, comprises between 0.5-30% by weight of a flame retardant, such as a nitrogen-containing component like melamine polyphosphate.
11. Decorative panel according to any of the preceding clauses, wherein the core layer and/or the decorative layer and/or the backing layer comprises up to 50% by weight of melamine cyanurate, preferably between 5 and 40%.
12. Decorative panel according to clause 11, wherein the melamine cyanurate is preferably composed of particles with average particle diameter up to 120 μm, particularly preferably from 1 μm to 25 μm, very particularly preferably from 1 μm to 10 μm and wherein the melamine particles are preferably surface-treated or coated or sized with silicon-containing compounds, in particular based on organofunctional silanes or organosiloxanes.
13. Decorative panel according to any of the preceding clauses, wherein the coupling parts, at the decorative side of the core, comprise a recessed portion in the form of a bevel or grout, wherein at least a decorative side of the recessed portion comprises the glass particles, wherein preferably at least a portion of the glass particles extend from the recessed portion to form a structured bevel or grout.
14. Decorative panel according to any of the preceding clauses, wherein the glass particles are non-fibrous glass particles.
15. Decorative panel according to any of the preceding clauses, wherein the glass particles are uncoated glass particles.
16. Decorative panel according to any of the preceding clauses, wherein the glass particles are uncoated glass beads.
17. Decorative panel according to any of the preceding clauses, wherein the glass particles are poled glass particles.
18. Decorative panel according to any of the preceding clauses, wherein, in average, less than 50% of the outer surface of the glass particles is adhered to the thermoplastic matrix material, and wherein, in average, more than 50% of the outer surface of the glass particles is positioned at a distance from the thermoplastic matrix material.
19. Decorative panel according to any of the preceding clauses, wherein at least a fraction, preferably the majority, of the cavities has an elongated shape.
20. Decorative panel according to any of the preceding clauses, wherein at least one coupling profile of said first coupling profile and said second coupling profile is adapted to deform during coupling process of adjacent decorative panels.
21. Decorative panel according to any of the preceding clauses, wherein at least one coupling profile of said first coupling profile and said second coupling profile is configured to remain deformed state, in coupled condition of adjacent decorative panels.
22. Decorative panel according to any of the preceding clauses, wherein the core layer comprises conductive particles, such as carbon particles, dispersed in the thermoplastic matrix material.
23. Decorative panel according to any of the preceding clauses, wherein at least 90% of the glass particles has a diameter which is smaller than 30 μm.
24. Decorative panel according to any of the preceding clauses, wherein at least one thermoplastic material is chosen from the group consisting of: polypropylene (PP), thermoplastic polyurethane (TPU), polystyrene (PS), polyethylene (PE), polyethylene terephthalate (PET), polyethylene terephthalate glycol (PETG), polyvinyl chloride (PVC), and a furan resin.
25. Decorative panel according to any of the preceding claims, wherein the first coupling profile and the second coupling profile make integral part of the core layer.
26. Decorative covering composed of a plurality of, preferably interconnected, decorative panels according to any of the preceding clauses.
27. Method for producing a decorative panel according to any of the preceding clauses, comprising the steps of:
a) mixing a core layer material and/or a decorative layer material with glass particles;
b) extruding at least one core layer and preparing at least a part of at least one decorative layer, preferably coextruding at least one core layer and at least one decorative layer,
c) mutually adhering said core layer and said decorative layer, preferably by means of hot pressing and/or calendaring,
d) affixing, either directly or indirectly, at least a part of a decorative top structure to an upper side of the decorative layer,
e) optionally, affixing, either directly or indirectly, a backing layer to a lower side of the coextruded layer, and
f) optionally, affixing, either directly or indirectly, a transparent layer on an upper side of the exposed portion of the decorative layer,
g) optionally, profiling at least two panel edges, in particular at least two core edges, to form complementary first and second coupling profiles.

### BRIEF DESCRIPTION OF THE DRAWINGS

The terms Fig., Figs., Figure, and Figures are used interchangeably in the specification to refer to the corresponding figures in the drawings.

The invention will be elucidated on the basis of non-limitative exemplary embodiments shown in the following figures. Herein:

FIG. 1 shows a panel according to the present invention;

FIG. 2 is a cross-sectional view indicated by section A-A in FIG. 1;

FIG. 2a schematically shows a detailed section of the panel according to the present invention

FIG. 3 is a cross-sectional view indicated by section B-B in FIG. 1;

FIGS. 4a-4f show different views of the successive steps for interconnecting multiple panels according to FIGS. 1-3 for forming a covering; and

FIGS. 5a-5e show different embodiments of the first and second edges of a panel according to the invention; and

### DESCRIPTION OF THE INVENTION

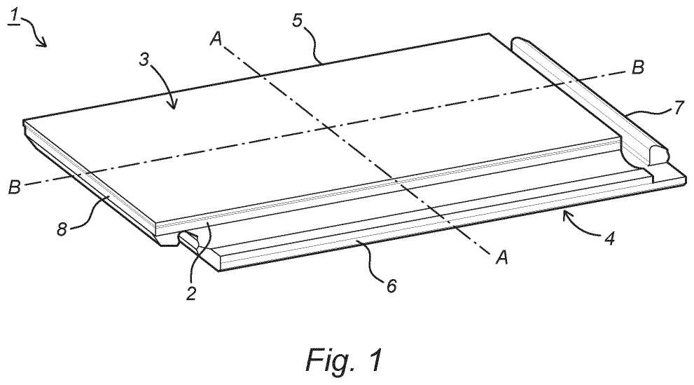

FIG. 1 shows a rectangular panel 1 according to the present invention. The panel 1 is interconnectable with similar panels for forming a covering, as will be shown in further figures. The panel 1 can be made of any material, though typical materials plastic, in particular thermoplastic, more in particular PVC. Commonly, the panel 1 is made of a laminate comprising a central layer (core layer) enclosed by a backing structure and a decorative top structure (not shown). The top structure commonly comprises a decorative layer, which may be printed onto the central layer, on top of which a protective layer may be applied. The panel 1 comprises a centrally located core 2 provided with an upper or decorative side 3 and a lower or support side 4. The core 2 is integrally connected with a first pair of opposite edges, in particular a first edge 5 and a complementary second edge 6, located at the long lateral sides of the panel 1. The core is also integrally connected with a second pair of opposite edges, in particular a third edge 7 and a complementary fourth edge 8, located a the short sides of the panel 1 in this exemplary embodiment.

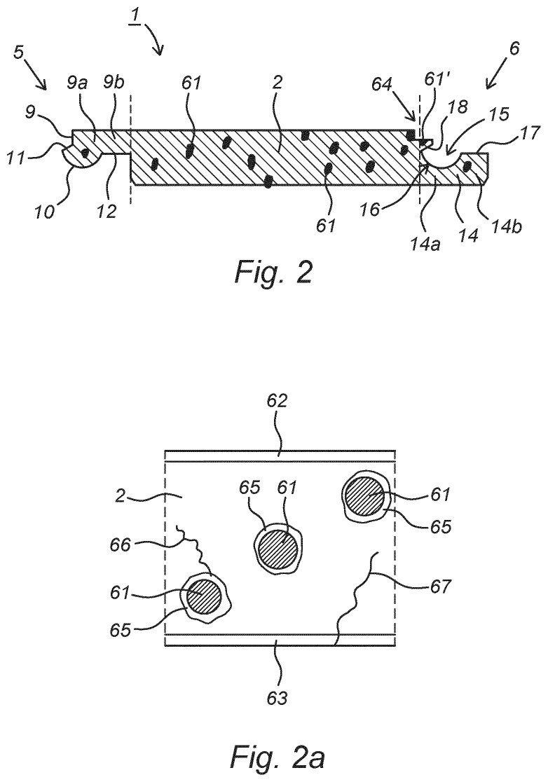

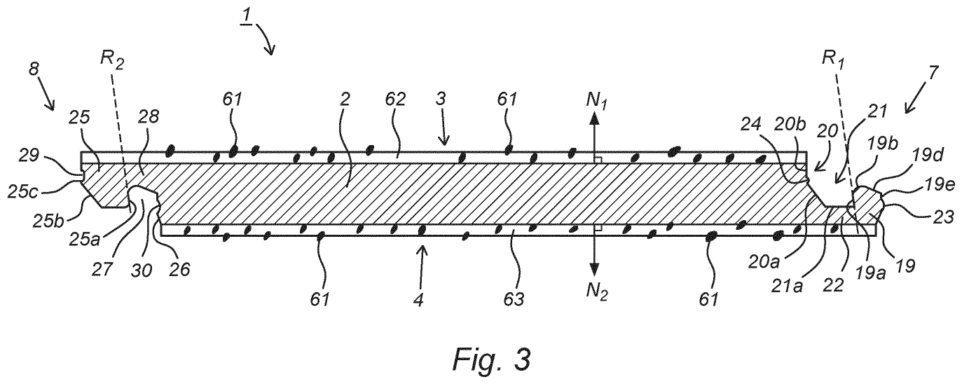

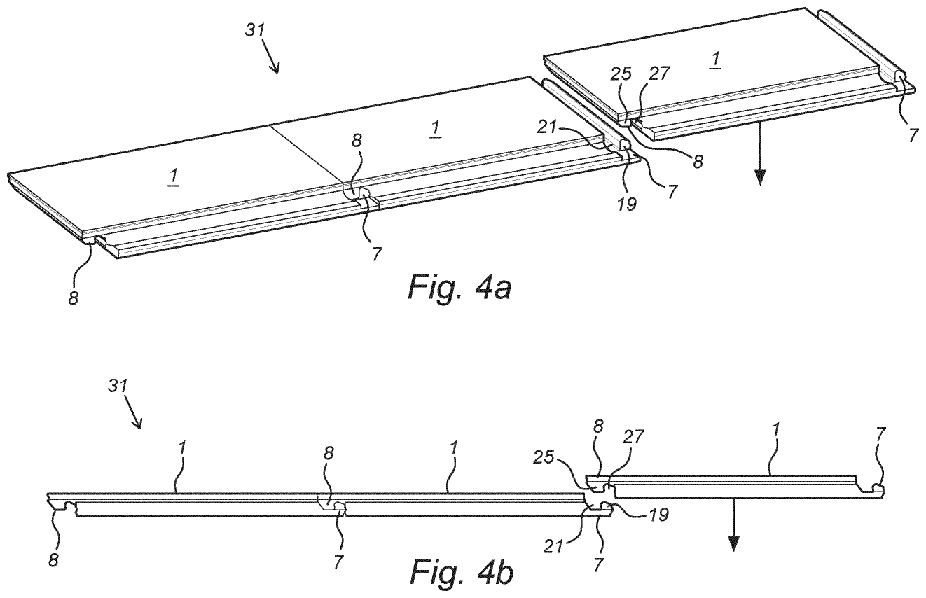

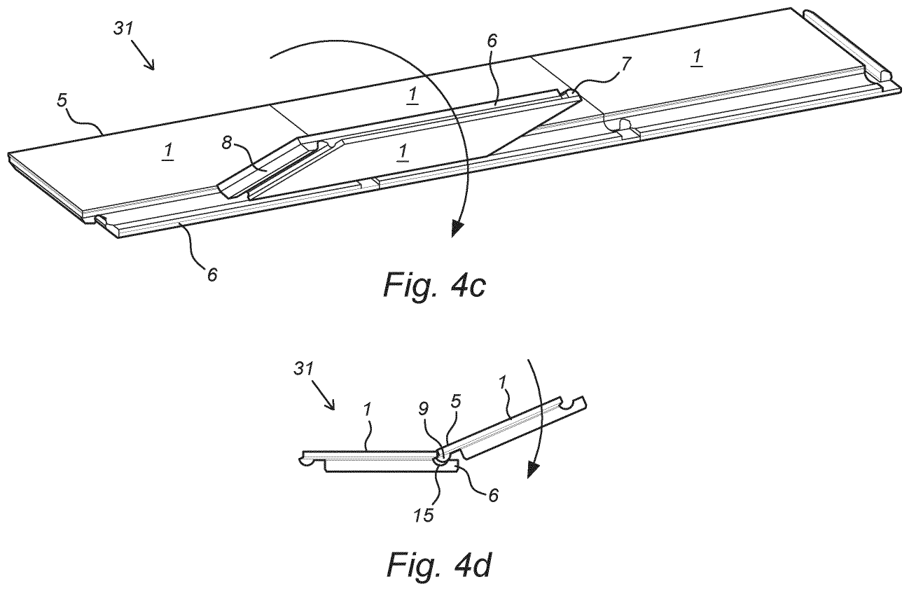

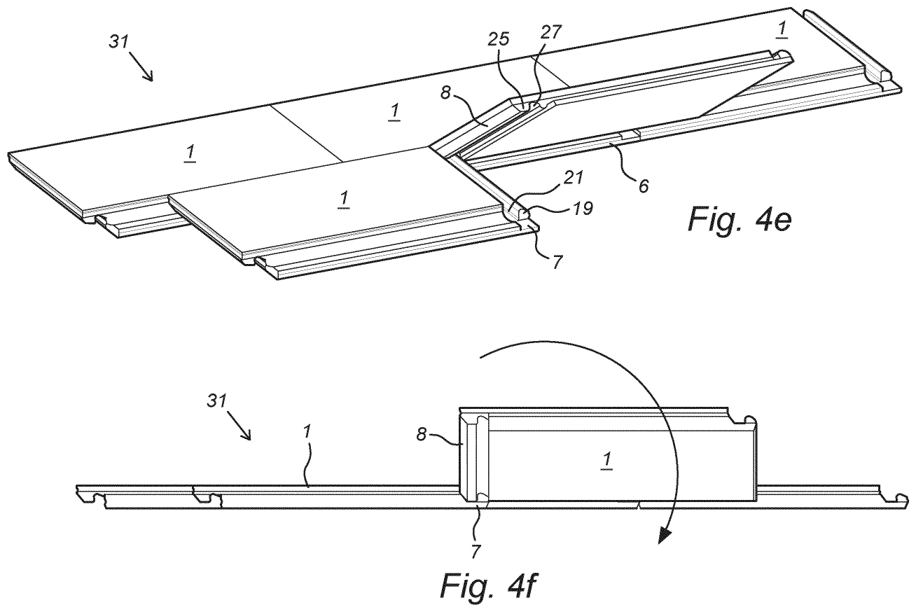

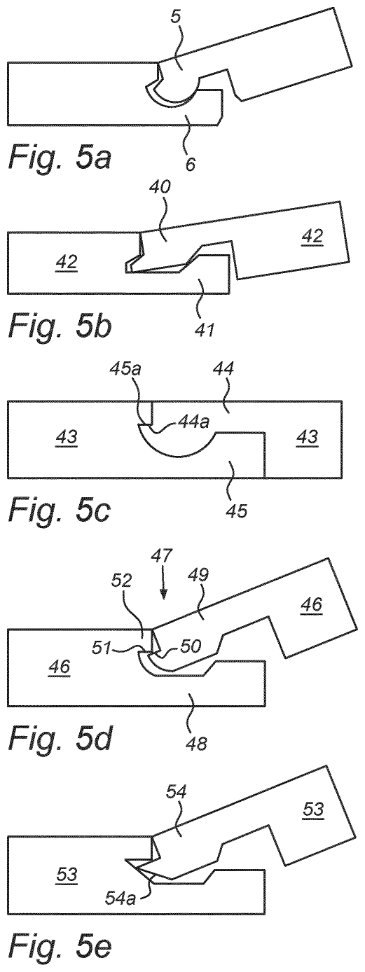

FIG. 2 is a cross-sectional view indicated by section A-A in FIG. 1. In this cross-section, the shape of the complementary first edge 5 and second 6 edge are shown in detail. The first edge 5 comprises a sideward tongue 9 which is integrally connected to the core 2. By means of the vertical dashed line the border between the sideward tongue 9 and the core 2 is visualised. A front region 9a of the sideward tongue 9 is provided with a rounded bottom surface 10. An outer end of the rounded bottom surface 10 adjoins an inclined locking surface 11. An opposite end of the rounded bottom surface 10 adjoins a bearing surface 12 making part of a back region 9b of the sideward tongue 9. The second edge 6 of the panel 1 comprises an upper lip 13 and a lower lip 14 defining a recess 15. Both lips 13, 14 are integrally connected to the core 2. By means of the vertical dashed line the border between the lips 13, 14 and the core is visualised. As shown in FIG. 2, the width of the upper lip 13 is substantially smaller than the width of the lower lip 14. The recess 15 has a shape which is complementary to the shape of the sideward tongue 9. More in particular, a top surface 16 of a back region 14a of the lower lip 14 has a (complementary) rounded shape, configured to co-act with the rounded front region 9a of the sideward tongue 9, while a front region 14b of the lower lip 14 is provided with a upwardly protruding shoulder 17, configured to co-act with the bearing surface 12 of the sideward tongue 9. A lower surface 18 of the upper lip 13 is inclined and corresponds to the locking surface 11 of the sideward tongue 9. Locking at the first edge 5 and the second edge 6 of adjacent panels 1 by insertion of the sideward tongue 9 of a panel 1 to be coupled into the recess 15, wherein said panel 1 is initially held in an inclined position. After insertion of the sideward tongue 9 into the recess, the panel 1 to be coupled will be pivoted (angled) in downward direction about an axis parallel to the first edge 5 until both panels 1 are positioned in the same—commonly horizontal—plane, wherein the locking surface 11 of the sideward tongue 9 will engage the locking surface of the upper lip 18, and wherein at least a bottom front part is accommodated substantially form-fittingly in the recess 15, and wherein the bearing surface 12 is supported by the shoulder 17. Locking at the first edge 5 and the second edge 6 leads to locking of the connected panels 1 in both horizontal direction and vertical direction. The angling down locking principle of the first and second edges 5, 6 is a relatively easy locking principle which facilitates mutual coupling of panels at these edges 5, 6 tremendously. Further details relating to this locking mechanism are visualised in FIGS. 4 and 5. FIG. 2 further schematically shows a grout 64 at the second edge 6, in the form of a rectangular recess. On the bottom of the recess 64 schematically a glass particle 61′ is shown, to provide texture to the grout 64. The core layer 2 is provided with glass particles 61 as well. For sake of overview only the core layer 2 is shown with glass particles 61 and no decorative layer or back layer are shown in FIG. 2, although such layers and particles are shown in FIG. 3. In practise these inclusions and layers are interchangeable.

FIG. 2a schematically shows a zoomed in or detailed portion of the core 2. The central layer or core 2 is provided with glass particles 61, of which three are shown. The material of the core 2 surrounds the glass particles 61, although around the glass particles a void or air cavity 65 is shown. Schematically indicated are also two cracks 66, 67. The crack 66 on the left is formed centrally and encounters the air cavity 65 on the bottom left upon progression, where the crack 66 stops. The crack 67 on the right does not encounter such air cavity and ultimately extends to the backing layer 63, which would be more damaging to the panel compared to the resolved crack 66 on the left.

FIG. 3 is a cross-sectional view indicated by section B-B in FIG. 1. In this cross-section, the shape of the complementary third edge 7 and second 8 edge are shown in detail. The third edge 7 comprises an upward tongue 19, an upward flank 20 and an upward groove 21 formed between upward tongue 19 and upward flank 20. The upward tongue 19 is connected to the core 2 by means of a bridge 22, which is preferably resilient to some extent. A side 19a of upward tongue 19 facing toward upward flank 20 extends in the direction of the normal N1 of the upper side 3 of the core 2. The tangent R1 and the normal N1 of the upper side 3 of the core 2 are thus directed toward each other (converging orientation), wherein the angle enclosed by R1 and N1 is preferably between 0 and 10 degrees in this exemplary embodiment. Due to the converging orientation of the upward flank 20 and the side 19a of the upward tongue 19 facing toward to the upward flank 20, the upward groove 22 is a closed groove, which is only accessible to a complementary counterpart by deformation of the upward tongue 19 and/or bridge 22. Another side 19b of upward tongue 19 facing toward upward flank 20 forms an aligning edge enabling facilitated realization of a coupling to an adjacent panel 1. As shown, this side 19b functioning as aligning edge is directed away from the normal N1 of upper side 3 of the core 2. An upper side 19d of upward tongue 19 does however extend in the direction of the normal N1 of the upper side 3 of the core 2, and runs inclining downward in the direction of the side 19e of upward tongue 19 facing away from upward flank 20. This chamfering provides the option of giving the complementary fourth edge 8 a more robust and therefore stronger form. A part of the side 19e of upward tongue 19 facing away from upward flank 20 is oriented substantially vertically and is moreover provided with an outward bulge 23. A lower part 20a of upward flank 20 is oriented diagonally, while an upper part 20b of upward flank 20 is shown to be substantially vertical and forms a stop surface for fourth edge 8. In between the inclined part 20a and the substantially vertical part 20b of the upward flank an additional coupling element, in particular an additional bulge 24, is provided. A lower wall part 21a of upward groove 21 is oriented substantially horizontally in this exemplary embodiment.

The fourth edge 8 is substantially complementary to third edge 7. The fourth edge 8 comprises a downward tongue 25, a downward flank 26 and a downward groove 27 formed between downward tongue 25 and downward flank 26. The downward tongue 25 is connected to the core 2 by means of a bridge 28, which is preferably resilient to some extent. A side 25a of downward tongue 25 facing toward downward flank 26 lies in the direction of the normal N2 of the lower side 4 of the core 2. This means that a tangent R2 of side 25a of downward tongue 25 and the normal of the lower side 4 of the core 2 are mutually converging, wherein the angle enclosed by R2 and N2 is preferably between 0 and 10 degrees in this exemplary embodiment. More preferably, the inclination of R1 is identical to the inclination of R2; hence, R1 and R2 are preferably parallel. Due to the converging orientation of the downward flank 26 and the side 25a of the downward tongue 25 facing toward to the downward flank 26, the downward groove 27 is a closed groove, which is only accessible for the upward tongue 19 of an adjacent panel 1 by deformation of the downward tongue 25 and/or bridge 28, as a result of which the entrance of the downward groove can be widened (temporary).

A side 25b of the downward tongue 25 facing away from downward flank 26 is diagonally oriented, but has a flatter orientation than the complementary side 20a of upward flank 20, whereby a gap (air space) will be formed in the coupled position, which will generally facilitate coupling between two panels 1. The inclining side 25b of downward tongue 25 also functions as aligning edge for the purpose of further facilitating coupling between two panels 1. Another side 25c facing away from downward flank 26 takes a substantially vertical form, though is provided with a small cavity 29 configured to co-act with the additional bulge 24 of another panel 1. A top part of the side 25c facing away from downward flank 26 forms a complementary stop surface for stop surface 20b of upward flank 20 (of an adjacent panel). Downward flank 26 is oriented substantially vertically and is provided with a recess 30 adapted to receive the outward bulge 23 of the upward tongue 19 (of an adjacent panel).

FIG. 3 further schematically shows glass particles 61 embedded in a decorative layer 62 on top of the core layer 2 as well as in a backing layer 63 on the bottom of the core layer 2.

FIGS. 4a-4f show different views of the successive steps for interconnecting multiple panels 1 according to FIGS. 1-3 for forming a covering 31. FIGS. 4a and 4b relate to the first step of the installation process, wherein a first row of panels 1 is generated by connecting the third edge 7 of a panel 1 to the fourth edge 8 of an adjacent panel, by pressing—in a substantially vertical direction (as indicated by the arrow)—the fourth edge 8 of a panel 1 to be coupled onto and into the third edge 7 of an already installed panel 1. Due to the vertical displacement, the third edge 7 and/or the fourth edge 8 will be deformed slightly, such that the downward tongue 25 will be pushed into the upward groove 21, and the upward tongue 19 will be pushed into the downward groove 27. Moreover, the bulges 23, 24 will be positioned in the corresponding recesses 29, 30 to better secure the panels 1 with respect to each other. Due to this temporary deformation, wherein both the upward groove 21 and the downward grove 27 will be widened temporary for the insertion of the downward tongue 25 and the upward tongue 19 respectively, both edges 7, 8 will snap into each other.

FIGS. 4c and 4d relate to the second step of the installation process, wherein a second row of panels 1 is created which is connected to the first row of panels. To this end, a first edge 5 of a panel 1 to be coupled is positioned in an inclined orientation against a second edge 6 of an already installed panel 1, such that the sideward tongue 9 is at least partially inserted in the complementary recess 15 of the second profile 6. After this partial insertion the inclined panel is pivoted (angled) down—see arrow—around an axis parallel to the first edge 5, until the panel 1 is located in the same plane as defined by the first row of panels, as a result of which the sideward tongue 9 will be locked into the recess 15 both in at least one horizontal direction and in vertical direction.

The first two steps as shown in FIGS. 4a-4d are preparatory steps for installation of one or more subsequent panels 1 which are to be coupled at multiple edges instead of only at a single edge. Installation of a subsequent panel 1 is visualised in FIGS. 4e and 4f. Again, a panel 1 to be coupled is held at inclined position, wherein the sideward tongue 9 of the panel 1 is inserted partially into the corresponding recess 15 of a second edge of at least one panel already installed. The fourth edge 8 of the panel 1 to be installed is positioned substantially above the third edge 7 of the panel 1 already installed in the second row, wherein the fourth edge 8 and the third edge 7 mutually enclose an angle (being the inclination angle of the panel to be coupled). During angling down of the panel 1 to be coupled (see arrow) both the first edge 5 and the fourth edge 8 of the panel 1 will be connected to adjacent panels 1. More in particular, during angling down of the panel 1, the front region of the sideward tongue 9 will be accommodated in the recess 15, and will be held in position by means of the limiting shoulder 17 and the limiting locking surface 18 of the upper lip 13 of the second edge 6 of the panel(s) already installed in the first row. Moreover, simultaneously the fourth edge 8 of the panel 1 to be coupled will make a downward scissoring movement with respect to the underlying third edge 7 and will zip (snap) into the third edge 7 and vice versa, leading to a firm and durable connection between the panels 1.

FIGS. 5a-5e show different embodiments of the first and second edges of a panel according to the invention. In FIG. 5a the embodiment according to FIGS. 1-4f is shown, while in FIGS. 5b-5e alternative embodiments of these edges are shown. More in particular, FIG. 5b shows a first and second edge 40, 41 of a panel 42, wherein, instead of a smoothly rounded bottom portion a more hooked (segmented rounded) bottom portion is shown. In FIG. 5c, an embodiment of a panel 43 is shown which is almost identical to the panel shown in FIG. 5a, though wherein the first and second edges 44, 45 are provided with horizontal locking surfaces 44a, 45b instead of inclined locking surfaces. In FIG. 5d, an alternative embodiment of a panel 46 is shown, wherein the first and second edges 47, 48 are shaped such that a bottom contact portion between the two edges 47, 48 is partially smoothly rounded and partially discontinuously rounded (segmented rounded). Locking surfaces 50, 51 of a sideward tongue 49 of the first edge 47 and of an upper lip 52 of the second edge have a substantially horizontal orientation. In FIG. 5e, an embodiment of a panel 53 almost identical to the panel 46 as shown in FIG. 5d is shown, with the difference that a front bottom part 54a of a sideward tongue 54 is not smoothly rounded, but flat giving a bottom portion of the sideward tongue 54 as such a segmented rounded (hooked) shape.

The above shown coupling parts are a shown to be illustrational but the invention may be used with a variety of different coupling parts as well, as long as they allow multiple panels to be coupled or connected.

Hence, the above-described inventive concepts are illustrated by several illustrative embodiments. It is conceivable that individual inventive concepts may be applied without, in so doing, also applying other details of the described example. It is not necessary to elaborate on examples of all conceivable combinations of the above-described inventive concepts, as a person skilled in the art will understand numerous inventive concepts can be (re)combined in order to arrive at a specific application. Various embodiments of the panel as described above and in the appended claims may be combined with this alternative panel configuration.

By “horizontal” is meant a direction which extends parallel to a plane defined by the panel, and which may intersect the core. By “vertical” is meant a direction which is perpendicular to said plane defined by the panel. The ordinal numbers used in this document, like “first”, “second”, and “third” are used only for identification purposes. Hence, the use of the expressions “third locking element” and “second locking element” does therefore not necessarily require the co-presence of a “first locking element”.

By “complementary” coupling profiles is meant that these coupling profiles can cooperate with each other. However, to this end, the complementary coupling profiles do not necessarily have to have complementary forms. The “panel” according to the invention may also applied as wall covering element, ceiling covering element, or alternative covering element. In case in this document reference is made to a “floor tile” or “floor panel”, these expressions may be replaced by expressions like “tile”, “wall tile”, “ceiling tile”, “covering tile” or “panel”.

It will be apparent that the invention is not limited to the working examples shown and described herein, but that numerous variants are possible within the scope of the attached claims that will be obvious to a person skilled in the art.

The verb “comprise” and conjugations thereof used in this patent publication are understood to mean not only “comprise”, but are also understood to mean the phrases “contain”, “substantially consist of”, “formed by” and conjugations thereof.

1-27. (canceled)

28. A decorative panel comprising:
at least one core layer provided with a support side and a decorative side;
a decorative top layer, affixed directly or indirectly to the decorative side of the core layer;
a first panel edge comprising a first coupling profile, and a second panel edge, opposing said first panel edge, comprising a second coupling profile being designed to engage interlockingly with said first coupling profile of an adjacent panel, both in horizontal direction and in vertical direction;
wherein the core layer is an extruded core layer and comprises at least one thermoplastic matrix material and glass particles dispersed within said thermoplastic matrix material, wherein cavities are enclosed by at least a fraction of said glass particles and said thermoplastic material.

29. The decorative panel according to claim 28, wherein the glass particles are uncoated glass particles.

30. The decorative panel according to claim 28, wherein the glass particles are uncoated glass beads.

31. The decorative panel according to claim 28, wherein the glass particles are poled glass particles.

32. The decorative panel according to claim 28, wherein, in average, less than 50% of the outer surface of the glass particles is adhered to the thermoplastic matrix material, and wherein, in average, more than 50% of the outer surface of the glass particles is positioned at a distance from the thermoplastic matrix material.

33. The decorative panel according to claim 28, wherein at least a fraction of the cavities has an elongated shape.

34. The decorative panel according to claim 28, wherein at least one coupling profile of said first coupling profile and said second coupling profile is configured to remain deformed state, in coupled condition of adjacent decorative panels.

35. The decorative panel according to claim 28, wherein glass particles are provided in the decorative top layer, wherein at least some of the glass particles extend outward of the decorative top layer to provide a textured top surface.

36. The decorative panel according to claim 28, comprising a back layer affixed directly or indirectly to the support side of the core layer, wherein the glass particles are provided in the back layer.

37. The decorative panel according to claim 28, wherein the core layer and/or the decorative top layer and/or the back layer comprise at least 15%, by weight or volume, glass particles.

38. The decorative panel according to claim 28, wherein the glass particles are glass spheres or wherein the glass particles are polyhedron shaped.

39. The decorative panel according to claim 28, wherein at least 90% of the glass particles has a diameter which is smaller than 30 μm.

40. The decorative panel according to claim 28, wherein the glass particles in particular have a d90 less than 150 μm.

41. The decorative panel according to claim 28, wherein the glass particles in particular have a d90 between 25 and 100 μm.

42. The decorative panel according to claim 28, wherein the core layer comprises a thermoplastic material, like PVC or polyamide like Nylon, wherein the glass particles are at least partially incorporated or embedded in the thermoplastic material.

43. The decorative panel according to claim 28, wherein the core layer comprises between 0.5-30% by weight of a flame retardant, such as a nitrogen-containing component like melamine polyphosphate.

44. The decorative panel according to claim 28, wherein the core layer and/or the decorative layer and/or the backing layer comprises up to 50% by weight of melamine cyanurate.

45. The decorative panel according to claim 44, wherein the melamine cyanurate is composed of particles with average particle diameter up to 120 μm, and wherein the melamine cyanurate particles are surface-treated or coated with silicon-containing compounds.

46. The decorative panel according to claim 28, wherein at least one thermoplastic material is chosen from the group consisting of: polypropylene (PP), thermoplastic polyurethane (TPU), polystyrene (PS), polyethylene (PE), polyethylene terephthalate (PET), polyethylene terephthalate glycol (PETG), polyvinyl chloride (PVC), and a furan resin.

47. A method for producing a decorative panel according to claim 28, comprising the steps of:
a) mixing a core layer material and/or a decorative layer material with glass particles;
b) extruding at least one core layer and preparing at least one decorative layer,
c) mutually adhering said core layer and said decorative layer,
d) affixing, either directly or indirectly, at least a part of a decorative top structure to an upper side of the decorative layer,
e) optionally, affixing, either directly or indirectly, a backing layer to a lower side of the coextruded layer, and
f) optionally, affixing, either directly or indirectly, a transparent layer on an upper side of the exposed portion of the decorative layer.
